(19) United States
(12) Patent Application Publication
(10) Pub. No.: US 2011/0136963 A1
(43) Pub. Date: Jun. 9, 2011

(54) METHOD FOR SNYTHESIZING AMPHIPHILIC GRADIENT COPOLYMERS SOLUBLE IN AN ALKALINE MEDIUM

(75) Inventor: Laurence Couvreur, Paris (FR)

(73) Assignee: Arkema France, Colombes (FR)

(21) Appl. No.: 13/058,383

(22) PCT Filed: Aug. 11, 2009
(86) PCT No.: PCT/FR2009/051581

§ 371 Date: Feb. 10, 2011

(30) Foreign Application Priority Data
Aug. 12, 2008 (FR) FR08/55548

(51) Int. Cl. C08F 2/38; C08F 20/06; C08F 2/16; C08F 2/06; C08F 2/44; C08L 33/02; C08L 53/00; C08F 299/04; C08K 3/22

(52) U.S. Cl. 524/521; 526/71; 526/318.6; 524/819; 526/208; 526/222; 524/853; 524/556; 525/294; 525/299; 524/779; 524/522

(57) ABSTRACT

The present invention relates to a process for the preparation of amphiphilic gradient copolymers by Controlled Radical Polymerization in the presence of a RAFT (Reversible Addition Fragmentation Transfer) agent. The copolymers of the invention exhibit low polydispersity indices and low viscosities in solution and are readily soluble in an alkaline medium.

The present invention relates to a process for the preparation of amphiphilic copolymers by Controlled Radical Polymerization in the presence of a RAFT (Reversible Addition Fragmentation Transfer) agent. The copolymers of the invention exhibit low polydispersity indices and low viscosities in solution and are readily soluble in an alkaline medium.

Copolymers, in particular based on styrene, on acrylic acid, and the like, are commonly resorted to in numerous uses, for example dispersion and grinding of pigments or latex stabilization. In latexes and paints in particular, it is important in addition for said copolymers to be soluble in alkaline media.

There currently exist three main routes for the synthesis of amphiphilic copolymers soluble in an alkaline medium: “conventional” radical synthesis, controlled radical synthesis (CRP), nitroxide route, and controlled radical synthesis, RAFT route.

The amphiphilic copolymers obtained by the “conventional” radical route generally have a relatively high polydispersity index (PI), as indicated, for example, in patent application EP 0 697 422. This patent application describes a method for the solution polymerization of a styrene (or substituted styrene) copolymer with a monomer having carboxyl functional groups and the use of the copolymers obtained in surface cleaning solutions. These copolymers have number-average molar masses (Mn) of between 500 g/mol and 50 000 g/mol and high polydispersity indices (typically between 1.8 and 7.5).

The paper which appeared in Macromolecular Chemistry and Physics, (2003), 204(17), 2055-2063, describes the production of amphiphilic copolymers from styrene and acrylic acid by controlled radical polymerization in the presence of nitroxide at 120° C. in dioxane under 2 bar with a level of solid of approximately 40%. This synthesis process employs a toxic reaction solvent and is carried out under pressure, thus making difficult production on the industrial scale.

A description is given, in the paper Macromolecules (2007), 40(6), 1897-1903, of the synthesis of random amphiphilic copolymers by CRP, nitroxide route, based on methacrylic acid and styrene, for styrene proportions of less than 8%, the styrene being used to facilitate the controlled polymerization of the methacrylic acid.

Controlled radical polymerization based on a RAFT agent is already known, in particular from the publications of international applications WO 98/01478, WO 99/05099 and WO 99/31144, which recommend the use of certain sulfur-comprising molecules of the family of the dithioesters, dithiocarbonates, dithiocarbamates and trithiocarbonates as transfer agents in order to obtain (co)polymers having narrow polydispersity indices and describe the “reversible addition-fragmentation polymerization” polymerization process.

The paper Macromolecules, (2007), 40(17), 6181-6189, describes the synthesis of polystyrene-b-poly(acrylic acid) block copolymers from two RAFT agents (of asymmetrical trithiocarbonate type). These syntheses are carried out in dioxane at 70° C. at a level of solid of the order of 23% by weight. This technique cannot be adapted to use on the industrial level due to the toxicity of the reaction solvent used (dioxane) and to the low level of solid observed in the product obtained.

The paper J. Polym. Mat. Sc., (2003), 41, 684-698, describes the one-pot synthesis of poly(acrylic acid)-b-poly(n-butyl acrylate) block copolymers by using dibenzyl trithiocarbonate or a xanthate as RAFT transfer agent, at levels of solid of the order of 35-40% by weight in methanol at reflux for the first poly(acrylic acid) block. The block copolymers thus obtained have variable compositions (20 to 50 acrylic acid units and 10 to 50 n-butyl acrylate units) with a number-average molecular weight (Mn) of less than 9000 g/mol and are characterized by a polydispersity index of between 1.4 and 2.3. This paper shows that the synthesis of amphiphilic copolymers by controlled radical polymerization, by using RAFT agents, is possible. However, only block copolymers having low levels of solids were obtained.

The paper Macromolecules, (2006), 39, 8632-8638, describes the synthesis of an acrylic acid/styrene gradient copolymer by controlled radical polymerization with a RAFT agent, said copolymer subsequently being used directly as seed for the emulsion synthesis of polystyrene or poly(n-butyl acrylate). The gradient copolymer is obtained in several stages, one of which consists of an addition of water to the copolymer, obtained in the gel form, until spontaneous phase inversion occurs and a translucent solution is obtained. The amount of water added is high since the level of solid disclosed is of the order of 12% by weight. In addition, the initial gel and the translucent solution comprise a high residual amount of monomers (approximately 45% by weight in the gel). An additional stage of conversion of the residual monomers at 60° C. for 12 hours is necessary in order to obtain a degree of conversion of 94% by weight. This process, in several stages carried out over a long period of time, is not appropriate either for use on the industrial scale.

The need thus remains for a process which is simple, which can be easily operated industrially and which employs compounds, in particular of reaction solvents, which are not or only very slight toxic, in particular to the environment.

Thus, one objective of the invention consists in providing a high-yield process for the synthesis of amphiphilic gradient copolymers which are soluble in alkaline media, which have a low polydispersity index and which have a high level of solid.

Another objective of the invention consists in providing a process for the synthesis of amphiphilic gradient copolymers which are soluble in alkaline media, which have a low polydispersity index and which have a high level of solid, said process being easily operated industrially and consuming little energy.

Yet other objectives will become apparent during the description of the invention which follows. These objectives are achieved in all or in part by virtue of the process which is now described below.

Thus, according to a first aspect, the present invention relates to a process for the preparation of an amphiphilic gradient copolymer by Controlled Radical Polymerization, in the presence of a RAFT (Reversible Addition Fragmentation Transfer) agent, comprising at least the following stages:
a) preparation of a reaction medium comprising at least one hydrophilic monomer which can be polymerized by the radical route, at least one hydrophobic monomer which can be polymerized by the radical route, at least one RAFT agent, at least one initiator and optionally at least one solvent;
b) heating the reaction medium with stirring at a temperature of between 40° C. and 150° C., preferably between 50° C. and 140° C., more preferably between 60° C. and 130° C.;
c) optional addition of one or more portions of water, in a total amount such that the level of solid, as amphiphilic copolymer formed at the end of the reaction, remains strictly greater than 40% by weight, whether the water has or has not been added to the reaction medium;
d) carrying out the reaction up to a degree of conversion of the monomers of greater than 80%, preferably strictly of greater than 80%, more preferably of greater than 90% and more preferably still of greater than 95%; and
e) recovery of the amphiphilic copolymer, after optional removal of the residual monomers and of the optional solvent or solvents.

Characteristically, just one reaction medium is formed in order to carry out therein the process according to the invention and the polymerization of the hydrophilic monomers and of the hydrophobic monomers takes place in a single stage.

In the process of the present invention, the hydrophilic monomer which can be polymerized by the radical route is chosen from the following monomers, which are spontaneously hydrophilic or which a simple conversion (quaternization of an amine or neutralization of an acid) renders hydrophilic in the polymer structure:
ethylenic carboxylic acids, such as acrylic acid, methacrylic acid, itaconic acid, fumaric acid or crotonic acid;
acrylates and methacrylates of polyethylene glycol or of glycol which are substituted or unsubstituted on their end functional group by alkyl, phosphate, phosphonate or sulfonate groups;
unsaturated carboxamides, such as acrylamide or methacrylamide and their N-substituted derivatives;
aminoalkyl acrylates and methacrylates, or aminoalkylmethacrylamides;
carboxylic anhydrides carrying a vinyl bond, such as maleic anhydride or fumaric anhydride;
vinylamides, such as vinylpyrrolidone or vinylacetamide;
vinylamines, such as vinylmorpholine or vinylamine;
vinylpyridine;
hydrophilic styrene derivatives, such as styrenesulfonic acid and its salts;
and the mixtures of two or more of them.

The term “hydrophilic monomer” is understood to mean, in the context of the invention, monomers which form water-soluble homopolymers.

The hydrophobic monomers are generally chosen from the following monomers:
styrene derivatives, such as styrene, α-methylstyrene, para-methylstyrene or tert-butylstyrene;
vinyl esters, such as vinyl acetate, vinyl propionate, vinyl butyrate, vinyl stearate, vinyl benzoate or vinyl esters of versatic acid;
linear or branched C₁-C₁₂ alkyl (meth)acrylate;
polyethylene glycol (meth)acrylate;
acrylonitrile and methacrylonitrile;
dienes, such as butadiene or isoprene;
and the mixtures of two or more of them.

The term “hydrophobic monomers” is understood here to mean the monomers which form water-insoluble homopolymers. The term “water-soluble” used here in connection with a polymer means that the polymer is soluble in water at 25° C. at a concentration by weight of at least 0.1%, preferably at least 1%, more preferably still of at least 5% and most preferably of at least 15%.

According to the process of the present invention, the mixture of the monomers to be polymerized, a radical polymerization initiator and a RAFT agent for controlling the polymerization are introduced into a stirred reactor optionally comprising at least one solvent. The proportions of hydrophilic monomer(s) and of hydrophobic monomer(s) in the starting reaction medium can vary within wide limits and in general the amount of hydrophilic monomer(s) is between 5% and 95% by weight, with respect to the total weight of monomer(s), preferably between 15% and 85% and more preferably between 25% and 75%.

Preference is very particularly given to the use, in the process of the invention, of hydrophilic monomers chosen from acrylic acid, methacrylic acid, sodium styrenesulfonate and polyethylene glycol (meth)acrylates and of hydrophobic monomers chosen from styrene, α-methylstyrene, n-butyl acrylate, ethyl acrylate and methyl methacrylate.

According to a preferred embodiment of the invention, use is made of the hydrophilic monomers (acrylic acid+Mᵢ) and of the hydrophobic monomers (styrene+Mₒ), where Mᵢ represents a hydrophilic monomer other than acrylic acid and Mₒ represents a hydrophobic monomer other than styrene and where the proportion (acrylic acid+Mᵢ)/(styrene+Mₒ) is between 5/95 and 95/5 by weight, preferably between 15/85 and 85/15, more preferably between 25/75 and 75125. According to a preferred alternative form, the proportion (acrylic acid+Mᵢ)/(styrene+Mₒ) is between 30/70 and 40/60 by weight. The amount of Mᵢ can vary from 0 to 99.9% by weight, with respect to the sum of the hydrophilic monomers, and the amount of Mₒ can vary from 0 to 99.9% by weight, with respect to the sum of the hydrophobic monomers.

Preference is very particularly given to the use of the following monomers:
acrylic acid/styrene, in a proportion of 30/70 to 50/50 by weight; or
acrylic acid/styrene/α-methylstyrene, in a proportion of ⅓/⅓/⅓ by weight.

The mixture of monomer(s) and more generally the reaction medium can be placed under an atmosphere of gas which is inert with regard to the radical polymerization, it being possible for said inert gas to be, for example, nitrogen or argon. The presence of inert gas is not, however, necessary.

The solvent of the reaction medium is preferably a solvent of the starting monomers and advantageously of the copolymer which would be formed. Mention may be made, among possible solvents, of water, linear or branched alcohols, glycols, such as diethylene glycol, propylene glycol monomethyl ether and dipropylene glycol monomethyl ether, dimethyl sulfoxide, alkyl esters, in particular alkyl acetates, such as, inter alia, butyl acetate or ethyl acetate, ketones, such as methyl ethyl ketone (MEK) or methyl isobutyl ketone (MIBK), and the mixtures of two or more of them.

The process of the invention can thus advantageously be carried out without the use of solvents which are regarded as harmful or toxic to the environment and/or the animal world and which are commonly used as indicated in the state of the art, such as dioxane, N-methylpyrrolidone, dimethylformamide, and others. According to a preferred embodiment, the process according to the invention is carried out in the absence of toxic and very toxic volatile organic compounds (VOCs) having in particular the following risk phrases: R33, R39, R40, R45, R46, R49 and R60 to R64.

The polymerization initiator used in the process of the invention can be any type of radical polymerization initiator known to the person skilled in the art and chosen in particular but without implied limitation from initiators of azo, peroxide or redox type.

The term “polymerization initiator” is understood to mean conventionally a chemical entity capable of producing free radicals.

Mention may be made, as examples of azo compounds, of 2,2′-azobisisobutyronitrile (AIBN).

Mention may be made, as examples of peroxide compounds, of tert-butyl peroxyacetate, tert-butyl peroxybenzoate (TBPO), dicumyl peroxide or dibenzoyl peroxide.

Mention may be made, as examples of redox compounds, of persulfates (such as, for example, potassium persulfate, sodium persulfate and ammonium persulfate), optionally in combination with a metabisulfite salt, for example sodium metabisulfite.

Generally, the polymerization initiator is added in an amount ranging from 1% to 50% by weight, with respect to the weight of RAFT transfer agent, preferably from 2% to 35% and more preferably still from 3% to 20%, for example approximately 5%.

The RAFT transfer agent employed in the process of the present invention can be of any type known to a person skilled in the art. Preference is given to the RAFT chain transfer agents corresponding to the following formula:

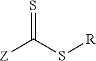

where R is chosen from —CH₂R¹, —CHR¹R′¹ and —CR¹R′¹R″¹, with R¹, R′¹ and R″¹, which are identical or different, each representing, independently of one another, a group chosen from optionally substituted alkyl, a saturated, unsaturated or aromatic carbocyclic or heterocyclic ring which is optionally substituted, optionally substituted alkylthio, optionally substituted alkoxy group, optionally substituted dialkylamino, organometallic group, acyl, acyloxy, carboxy (and its esters and/or salts), sulfonic acid (and its salts and/or sulfonates), alkoxy- or aryloxycarbonyl, and polymer chain prepared by any polymerization mechanism;
where Z is chosen from hydrogen, halogen (chlorine, bromine, iodine), optionally substituted alkyl, optionally substituted aryl, optionally substituted heterocycle, —SR², optionally substituted alkoxycarbonyl, optionally substituted aryloxycarbonyl (—COOR²), carboxy (—COOH), optionally substituted acyloxy (—OCOR²), optionally substituted carbamoyl (—CONHR², —CONR²R³), cyano (—CN), dialkyl- or diaryl phosphonato [—P(—O)OR²₂], dialkyl- or diary phosphinato [—P(═O)R²₂], polymer chain prepared by any polymerization mechanism, —OR² group and —NR²R³ group,
where R² and R³, which are identical or different, are selected from the group consisting of C₁ to C₁₈ alkyl, C₂ to C₁₈ alkenyl, C₆ to C₁₈ aryl, heterocyclyl, aralkyl, alkaryl, it being possible for each of these groups to be optionally substituted and in which the substituents are chosen from epoxy, hydroxyl, alkoxy, acyl, acyloxy, carboxyl (and its esters and/or salts), sulfonic acid (and its salts and/or sulfonates), alkoxy- or aryloxycarbonyl, isocyanato, cyano, silyl, halo and dialkylamino.

The R group as defined above can be released in the form of a radical R., which initiates the polymerization by free radicals.

Mention may in particular be made, among chain transfer agents, of dithioesters (compounds comprising at least one —C(═S)S— unit), dithiocarbonates or xanthates (compounds comprising at least one —O—C(═S)S— unit), dithiocarbamates (compounds comprising at least one —N—C(═S)S— unit) and trithiocarbonates (compounds comprising at least one —S—C(═S)S— unit).

Dithioesters which can advantageously be used in the context of the invention are those corresponding to the following formula (I):

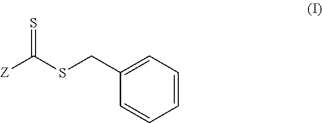

in which Z represents a group chosen from —C₆H₅, —CH₃, a pyrrole group, —OC₆F₅, a pyrrolidone group, —OC₆H₅, —OC₂H₅, —N(C₂H₅)₂ and advantageously the —S—CH₂—C₆H₅ group (dibenzyl trithiocarbonate or DBTTC) of following formula (II):

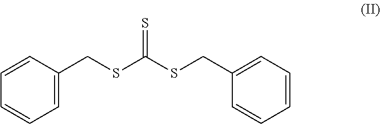

Preference is very particularly given to the chain transfer agents as defined above and which are liposoluble and water-insoluble or virtually water-insoluble. The transfer agent of formula (II) corresponds very particularly to these conditions.

Very particularly appropriate as chain transfer agents are DBTTC (CAS No. 26504-29-0) and its derivatives or also 2,2′-[carbonothioylbis(thio)]bis[propionic acid] (CAS No. 6332-91-8) or its salts, in particular the sodium salt (CAS No. 86497033-2). The RAFT agent entirely preferably used is dibenzyl trithiocarbonate (DBTTC) and its derivatives.

The amounts of chain transfer agents employed generally range from 0.1% to 10% by weight, preferably from 0.1% to 5% by weight and particularly from 0.1% to 3% by weight, with respect to 100% by weight of monomer(s).

The reaction is carried out at a temperature of between 40° C. and 150° C., preferably between 50° C. and 140° C. and more preferably between 60° C. and 130° C. The reaction can be carried out at atmospheric pressure or under slight pressure (such as, for example, at reflux of one or more of the compounds present in the reaction medium, in particular reflux of the solvent(s)).

It is possible, during the reaction, to add water to the reaction medium, for example in the case where it is desired to obtain a finished product which is an aqueous dispersion of amphiphilic copolymer. The addition of water can be carried out in one go or in two or more portions.

The total amount of water added can vary within wide limits but, in general, it is preferable for the amount of water added to be such that the theoretical level of solid as amphiphilic copolymer formed at the end of the reaction is strictly greater than 40% by weight. Whether or not water has been added to the reaction medium, it is essential for the level of solid in the solution of amphiphilic copolymer obtained as final product to remain greater than 40% by weight.

It is also possible to envisage the addition of an aqueous solution having a pH of greater than 7, advantageously of between 8 and 10, for example an aqueous ammonia, sodium hydroxide or potassium hydroxide solution. The addition of a basic aqueous solution is preferred in particular when one or more of the monomers comprise(s) acid functional groups, in particular carboxylic acid functional groups.

After the optional addition of water, the reaction is continued, in the presence or in the absence of water, until a degree of conversion of the monomers of greater than 80%, preferably strictly of greater than 80%, more preferably of greater than 90% and entirely preferably of greater than 95%, in other words to obtain the highest possible degree of conversion for obvious reasons, both economic and of ease of industrial processing (low amount of recycling of the unconverted starting materials and small amounts of solvent(s) and the like).

The degree of conversion can be measured in the reaction medium by any means known per se, such as NMR, gas chromatography, gravimetry, after optional dilution, and others.

On conclusion of the reaction, the amphiphilic copolymer can be isolated according to conventional methods known to a person skilled in the art. It is possible to recover the unreacted monomers and the optional solvent and to recycle them, if desired.

According to an alternative form, it is possible to envisage, on conclusion of the reaction, adding an additional amount of initiator, in or not in combination with a chain transfer agent, such as but not necessarily identical to the transfer agent used in the preceding stages, so as to convert a portion or all of the residual monomer(s).

In the case where the reaction was carried out with addition of water or of a basic aqueous solution, the copolymer is obtained and recovered in the form of an aqueous dispersion and can be used as is.

As a result of the radical copolymerization in the presence of RAFT agent comprising a thiocarbonylthio (—S—C(═S)—) group, this group is also present in the amphiphilic copolymers formed. The presence of such groups makes it possible in particular to use the amphiphilic copolymers for the synthesis of block copolymers.

Thus, the invention also applies to a process for the preparation of block copolymers, at least one of the blocks of which is a copolymer of the invention described above which has not been subjected to aftertreatment and the other block of which results from the polymerization of any type of monomer(s), chosen in particular from: alkyl (meth)acrylate, styrene and derivatives, functional (meth)acrylates with acid, anhydride, hydroxyl or amine functionality, poly(ethylene glycol) (polyethylene oxide), alone or as a mixture of two or more of them.

Said process is characterized by the use of at least one copolymer of the invention described above which has not been subjected to aftertreatment for the synthesis of a block copolymer, the other block(s) resulting from the polymerization of one or more of the monomers listed above.

However, in some applications, the presence of the thiocarbonylthio groups in the copolymers is not desirable due to their reactivity toward various sources of radicals (temperature, UV radiation, atmospheric oxygen, moisture, and the like).

Thus, and according to another alternative form, before or after the recovery of the amphiphilic copolymer, it is possible to envisage subjecting said copolymer to an aftertreatment, said aftertreatment having the effect of modifying the trithiocarbonyl groups with the aim of obtaining products which are more stable with regard to sources of radicals. Such aftertreatments are well known to a person skilled in the art and are, for example, described in patent applications WO 2002/090397, U.S. Pat. No. 6,919,409 and WO 2005/113612.

Such aftertreatments can also be envisaged when it is desired to improve the sulfurous odors of the amphiphilic copolymers directly obtained on conclusion of the reaction.

As replacement for or in addition to such an aftertreatment, it is possible to envisage adding one or more odor masking products or odorants to the amphiphilic copolymers. Such masking products or odorants can optionally be added during the copolymerization reaction, provided that they are inert with regard to said reaction. Thus, one or more odor masking products or odorants can be added during the copolymerization reaction, or else after said reaction, or alternatively during and after said copolymerization reaction.

Other additives can, of course, be added to the amphiphilic copolymers obtained according to the process of the present invention and mention may be made, among these, without implied limitation, of pigments, antioxidants, stabilizers and others, and also their mixtures.

The process according to the present invention makes it possible to obtain amphiphilic copolymers at low temperature (typically of less than 150° C.), at atmospheric pressure or under slight excess pressure, according to different methods of synthesis (“bulk” (solvent-free) synthesis, synthesis in a solvent medium, synthesis in an aqueous medium or also synthesis in an aqueous/organic (solvent+water) medium).

The amphiphilic copolymers thus obtained exhibit entirely advantageous characteristics and in particular being synthesized at high degrees of conversion and with controlled molar masses, while exhibiting low polydispersity indices.

The polydispersity index (PT) is defined by the Mw/Mn (weight-average molar mass/number-average molar mass) ratio, which is determined according to conventional methods known to a person skilled in the art and in particular by steric exclusion chromatography (SEC).

The amphiphilic copolymers obtained according to the process of the present invention thus exhibit low PI values, typically of between 1.2 and 2, generally between 1.2 and 1.8, more generally between 1.30 and 1.55.

The weight-average molar masses (Mw) of the amphiphilic copolymers of the process of the invention are generally between 1000 g/mol and 40 000 g/mol, preferably between 2000 g/mol and 30 000 g/mol and entirely preferably between 3000 g/mol and 20 000 g/mol.

By virtue of the characteristics defined above, the amphiphilic copolymers obtained according to the process of the present invention exhibit lower viscosities, in particular in solution, than the commercially available amphiphilic copolymers obtained according to processes by the conventional radical route.

The amphiphilic copolymers obtained according to the process of the present invention have uses in various fields of application, in particular as surfactants for stabilizing emulsions, or as dispersants for pigments and/or inorganic fillers, or also as agents for helping in the grinding of inorganic fillers, which are used in the preparation of formulations for paints, inks and other coating formulations.

Due to their low PI, the amphiphilic copolymers can be used in smaller amounts in comparison with the amounts used with similar copolymers exhibiting higher PI values.

The present invention is now illustrated by means of the following examples, which do not have the aim of limiting the invention.

### EXAMPLE 1

### Copolymerization of Styrene and Acrylic Acid in Solution in the Presence of DBTTC in a Solvent Medium

21.0 g of acrylic acid (i.e., 2.91 mol), 490 g of styrene (i.e., 4.77 mol), 1.045 g of azobisisobutyronitrile (i.e., 0.006 mol), 18.48 g of dibenzyl trithiocarbonate (i.e., 0.064 mol) and 124 g (i.e., 1.23 mol) of methyl isobutyl ketone are introduced into a polymerization reactor equipped with a variable-speed stirrer motor, inlets for the introduction of reactants, a nozzle for the introduction of inert gases which make it possible to drive off oxygen, such as nitrogen, measurement probes (e.g., for temperature), a system for condensation of vapors with reflux and a jacket which makes it possible to heat/cool the contents of the reactor by virtue of the circulation in the jacket of a heat-exchange fluid.

The reaction medium is brought to 80° C. and this temperature is maintained by thermal regulation for a few minutes and then various stationary temperature phases make it possible to reach a value of 125° C. in the reactor at the end of the polymerization.

After 7 hours, a conversion of approximately 100% is achieved and the reaction medium is withdrawn from the reactor. The degree of conversion is calculated in the following way: the conversion is followed by withdrawn samples which are immediately cooled in ice and monitored by solids content with a thermobalance at 140° C. (Mettler Toledo HB43). The thermobalance makes it possible to determine the amount of solid present in the withdrawn sample and thus to go back to the level of solid of said sample [level of solid at time t=(starting weight−final weight)/starting weight]. The monitoring with regard to the final withdrawn sample is repeated, if necessary, by GC (gas chromatography) analysis. The conversion by weight=(1−Level of solid at t)/Theoretical level of solid (level of solid as polymer if all of the monomers are converted).

The molecular weights of the polymer as polystyrene (PS) equivalent, determined by SEC, are 9000 g/mol for the number-average molar mass (Mn) and 13 200 g/mol for the weight-average molar mass (Mw). The polydispersity index is 1.47. Before carrying out the analysis by SEC and as amphiphilic polymers cannot be analyzed by standard methods, the acid functional groups were modified to give methyl ester functional groups by use of trimethylsilyldiazomethane in solution. The polymers thus modified are therefore completely lipophilic and can be analyzed under conventional SEC conditions. The dried polymers are analyzed by steric exclusion chromatography (SEC) in THF at 40° C. at 1 g/l with a flow rate of 1 ml/min on a set of 2 PLgel MIXED B (30 cm) columns with a refractometric and UV detector. The results of the molar masses and distribution are expressed as polystyrene (PS) equivalents.

### EXAMPLE 2

### Polymerization of Styrene and Acrylic Acid in the Presence of DBTTC in Solution

The reactor used and the procedure are identical to those mentioned in example 1.

150 g of acrylic acid (i.e., 2.08 mol), 350 g of styrene (i.e., 3.36 mol), 0.68 g of Luperox® DI (Arkema) (i.e., 0.005 mol), 13.20 g of dibenzyl trithiocarbonate (i.e., 0.045 mol) and 91 g (i.e., 0.91 mol) of methyl isobutyl ketone are introduced into the reactor. The reaction medium is brought to 80° C. and this temperature is maintained by thermal regulation for a few minutes and then various stationary temperature phases make it possible to reach a value of 130° C. in the reactor at the end of the polymerization.

After 6 hours, a conversion of approximately 100% is achieved and the reaction medium is withdrawn from the reactor.

The molecular weights of the polymer as polystyrene (PS) equivalent, determined by SEC, are 8700 g/mol for the number-average molar mass (Mn) and 13 200 g/mol for the weight-average molar mass (Mw). The polydispersity index is 1.51.

### EXAMPLE 3

### Polymerization of styrene and acrylic acid in the presence of disodium salt of 2,2′-[carbonothioylbis(thio)]bis[propanoic acid] in solution

The reactor used and the procedure are identical to those mentioned in examples 1 and 2.

150 g of acrylic acid (i.e., 2.08 mol), 277 g of styrene (i.e., 2.66 mol), 0.58 g of Luperox° DI (Arkema) (i.e., 0.004 mol), 21.50 g of disodium salt of 2,2′-[carbonothioylbis(thio)]bis[propanoic acid] (i.e., 0.074 mot) at 378 g (i.e., 0.91 mol) of methyl ethyl ketone are introduced into the reactor. The reaction medium is brought to 120° C. and this temperature is maintained by thermal regulation. After 7 hours, a conversion of approximately 83% is reached and the reaction medium is withdrawn from the reactor.

The molecular weights of the polymer as polystyrene (PS) equivalent, determined by SEC, are 7350 g/mol for the number-average molar mass (Mn) and 10 420 g/mol for the weight-average molar mass (Mw). The polydispersity index is 1.42.

The data relating to examples 1, 2 and 3 are combined in table 1 below:

TABLE 1

| | | | Level of | Reaction | | | | Polydispersity |
|---|---|---|---|---|---|---|---|---|
| | | AA/St | solid (% by | temperature | Duration | Degree of | Mw | index |
| Example | Solvent | ratio* | weight) | (° C.) | (min) | conversion | (g/mol) | (Mw/Mn) |
| 1 | MIBK | 30:70 | 85 | 80-125 | 420 | 0.99 | 13 200 | 1.47 |
| 2 | MIBK | 30:70 | 85 | 80-130 | 360 | 0.99 | 13 200 | 1.51 |
| 3 | MEK | 35:65 | 50 | 120 | 420 | 0.83 | 10 420 | 1.42 |

*ratio by weight; AA: acrylic acid; St: styrene

### EXAMPLE 4

### Polymerization of Styrene and Acrylic Acid in the Presence of DBTTC, Successive Bulk then Aqueous Dispersion Process

The reactor used and the procedure are identical to those mentioned in example 1. Example 4a is carried out according to the following data:

72 g of acrylic acid (i.e., 1 mol), 168 g of styrene (i.e., 1.61 mol), 0.359 g of azobisisobutyronitrile (i.e., 0.002 mol) and 6.35 g of dibenzyl trithiocarbonate (i.e., 0.020 mol) are introduced. This solution is stirred at 250 revolutions/min at 75° C. until a conversion of 45% is obtained. When this conversion is achieved, 240 g of preheated water are added to the reactor with stirring at 500 revolutions/min. At the same time, a temperature gradient is set underway over 60 minutes in order to obtain a temperature of 90° C. After polymerizing for 3 hours, 480 g of an aqueous ammonia solution are added (pH=10). This dispersion is stirred for an additional 5 hours and a conversion of 90% is thus obtained.

An additional stage of cooking by addition of an initiator (0.08 g of PRS or sodium persulfate) makes it possible, over 2 hours of additional polymerization, to obtain a conversion of greater than 95%.

Similarly, examples 3b to 3e are carried out. The reaction times, temperatures and amounts of water added are presented in table 2 below:

TABLE 2

| | | | | | 1st | | | |
|---|---|---|---|---|---|---|---|---|
| | AA/St | Time | T | Conv. 1 | addition | Time | T | Conv. 2 |
| Ex. | ratio | (min) | (° C.) | (%) | Water (g) | (min) | (° C.) | (%) |
| 4a | 30:70 | 150 | 75 | 45 | 240 | 90 | 90 | 74 |
| 4b | 30:70 | 150 | 70-75 | 36 | 80 | 80 | 75 | 50 |
| 4c | 30:70 | 120 | 75 | 35 | 80 | 45 | 90 | 62 |
| 4d | 30:70 | 150 | 75 | 54 | 275 | 80 | 90 | 83 |
| 4e | 30:70 | 150 | 75 | 50 | 280 | 80 | 90 | 82 |

| | 2nd | | | | | | | |
|---|---|---|---|---|---|---|---|---|
| | addition | | | | Conv. 4 | | | |
| | Water + | | | | Post- | | | |
| | NH₃ | Time | T | Conv. 3 | cooking | Mn^{b} | Mw^{b} | Mw/ |
| Ex. | (g) | (min) | (° C.) | (%) | for 2 h | (g/mol) | (g/mol) | Mn^{b} |
| 4a | 480 | 240 | 90 | 90 | 96 | 8200 | 12 100 | 1.48 |
| 4b | 640 | 210 | 80-90 | 87 | — | 7000 | 10 600 | 1.51 |
| 4c | 640 | 315 | 90 | 85 | 93 | 6800 | 10 200 | 1.50 |
| 4d | 440 | 250 | 90 | 94 | — | 9000 | 12 400 | 1.38 |
| 4e | 440 | 250 | 90 | 92 | — | 9700 | 13 500 | 1.39 |

### EXAMPLE 5

### Comparison of the Behavior of the Copolymers in Alkaline Solution

A comparative study is carried out with respect to the commercial product Joncryl® 678, on the solubilities in alkaline solution and on the viscosities observed.

To do this, a 28% Normapur aqueous ammonia solution is diluted with distilled water until a pH of 12 is achieved. 3 g of a sample of dry copolymer to be tested (according to the invention or commercial product Joncryl® 678) are weighed out in a glass flask and then 7 g of the aqueous ammonia solution at pH=12 prepared above are added. The level of solid (SC) is 30%. The combined mixture is vigorously stirred at ambient temperature until the polymer has completely dissolved, after which the pH is measured (using pH paper).

The viscosity is measured on a Brookfield type LVTCP viscometer, the temperature of which is regulated by a Haake D8 bath.

One of the following two cones is used, depending on the apparent viscosity of these solutions:
CP41 for viscosities ranging from 19.2 to 3840 cP (2 ml sample),
CP51 for viscosities ranging from 80.9 to 16 180 cP (0.5 ml sample).

The results are collated in the following table 3:

TABLE 3

| | | | | Aqueous | | |
|---|---|---|---|---|---|---|
| | | | | ammonia | Viscosity^{c} | Viscosity^{c} |
| | | | | neutralization | at 25° C. | at 50° C. |
| | | Mw | | (SC* = | (SC* = | (SC* = |
| Ex. | Composition^{a} | (g · mol⁻¹)^{b} | Mw/Mn^{b} | 30%) | 30%) | 30%) |
| Joncryl ® | St/AMS:AA | 9300 | 2.44 | Only at | ≈4000 cP | ≈500 cP |
| 678 | 1:1:1 | | | 50° C. | | |
| | | | | when pH | | |
| | | | | >9.5 | | |
| 1 | St/AA | 8900 | 1.41 | AT** | ≈1500 cP | ≈130 cP |
| | 2:1 | | | <1 h | | |
| 2 | St/AA | 13 200 | 1.51 | AT** | ≈3400 cP | ≈500 cP |
| | 2:1 | | | <1 h | | |
| 4b | St/AA | 10 600 | 1.51 | Immediate | ≈150 cP | ≈20 cP |
| | 2:1 | | | | | |
| 4c | St/AA | 10 200 | 1.50 | Immediate | ≈2200 cP | ≈250 cP |
| | 2:1 | | | | | |

^{a}St: Styrene, AMS: α-methylstyrene, AA: acrylic acid;
^{b}SEC/PS grading after methylation;
^{c}viscosity of the solution;
*SC = solids content;
**AT = ambient temperature

1. A process for the preparation of an amphiphilic gradient copolymer by Controlled Radical Polymerization, in the presence of a RAFT (Reversible Addition Fragmentation Transfer) agent, comprising at least the following stages:
a) preparing a reaction medium comprising at least one hydrophilic monomer which can be polymerized by the radical route, at least one hydrophobic monomer which can be polymerized by the radical route, at least one RAFT agent, at least one initiator and optionally at least one solvent;
b) heating the reaction medium with stirring at a temperature of between 40° C. and 150° C.;
c) optionally adding one or more portions of water, in a total amount such that the level of amphiphilic copolymer solids formed at the end of the reaction, is greater than 40% by weight;
d) carrying out the reaction up to a degree of conversion of the monomers of greater than 80%; and
e) recovering the amphiphilic copolymer, after optional removal of the residual monomers and of the optional solvent or solvents.

2. The process as claimed in claim 1, wherein the hydrophilic monomer which can be polymerized by the radical route is chosen from monomers, which are spontaneously hydrophilic or which a simple conversion, such as the quaternization of an amine or the neutralization of an acid, renders hydrophilic in the polymer structure, wherein said monomer is selected from the group consisting of:
ethylenic carboxylic acids, acrylic acid, methacrylic acid, itaconic acid, fumaric acid, crotonic acid;
acrylates and methacrylates of polyethylene glycol or of glycol which are substituted or unsubstituted on their end functional group by alkyl, phosphate, phosphonate or sulfonate groups;
unsaturated carboxamides, acrylamide, methacrylamide and their N-substituted derivatives;
aminoalkyl acrylates, methacrylates, aminoalkylmethacrylamides;
carboxylic anhydrides carrying a vinyl bond, maleic anhydride, fumaric anhydride;
vinylamides, vinylpyrrolidone, vinylacetamide;
vinylamines, vinylmorpholine, vinylamine;
vinylpyridine;
hydrophilic styrene derivatives, styrenesulfonic acid and its salts;
and mixtures of two or more thereof.

3. The process as claimed in claim 1, wherein the hydrophobic monomer which can be polymerized by the radical route is selected from:
styrene derivatives, α-methylstyrene, para-methylstyrene, tert-butylstyrene;
vinyl esters, vinyl acetate, vinyl propionate, vinyl butyrate, vinyl stearate, vinyl benzoate, vinyl esters of versatic acid;
linear or branched C₁-C₁₂ alkyl (meth)acrylate;
polyethylene glycol (meth)acrylate;
acrylonitrile, methacrylonitrile;
dienes, such as butadiene, isoprene;
and mixtures of two or more thereof.

4. The process as claimed in claim 1, wherein the amount of hydrophilic monomer(s) is between 5% and 95% by weight, with respect to the total weight of monomer(s).

5. The process as claimed in claim 4, wherein said hydrophilic monomers, are acrylic acid and Mᵢ, and said hydrophobic monomers, are styrene and Mₒ, where Mᵢ represents a hydrophilic monomer other than acrylic acid and Mₒ represents a hydrophobic monomer other than styrene, and where the proportion (acrylic acid+Mᵢ)/(styrene+Mₒ) is between 5/95 and 95/5 by weight, the amount of Mᵢ being between 0 and 99.9% by weight, with respect to the sum of the hydrophilic monomers, and the amount of Mₒ being between 0 and 99.9% by weight, with respect to the sum of the hydrophobic monomers.

6. The process as claimed in claim 1, wherein the monomers employed are:
acrylic acid/styrene, in a proportion of 30/70 to 50/50 by weight; or
acrylic acid/styrene/α-methylstyrene, in a proportion of ⅓/⅓/⅓ by weight.

7. The process as claimed in claim 1, wherein the solvent is selected from water, linear or branched alcohols, glycols, diethylene glycol; dipropylene glycol monomethyl ether, dimethyl sulfoxide, alkyl esters, alkyl acetates, butyl acetate, ethyl acetate, ketones, methyl ethyl ketone (MEK), methyl isobutyl ketone (MIBK), and mixtures thereof.

8. The process as claimed in claim 1, wherein said RAFT agent corresponds to the following formula: 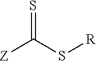
where R is chosen from —CH₂R¹, —CHR¹R′¹ and —CR¹R′¹R″¹, with R¹, R′¹ and R″¹, being identical or different, each representing, independently of one another, a group chosen from alkyl which is optionally substituted, a saturated, unsaturated or aromatic carbocyclic or heterocyclic ring which is optionally substituted, optionally substituted alkylthio, optionally substituted alkoxy group, optionally substituted dialkylamino, organometallic group, acyl, acyloxy, carboxy (and its esters and/or salts), sulfonic acid (and its salts and/or sulfonates), alkoxy- or aryloxycarbonyl, or a polymer chain prepared by any polymerization mechanism;
where Z is chosen from hydrogen, halogen (chlorine, bromine, iodine), optionally substituted alkyl, optionally substituted aryl, optionally substituted heterocycle, —SR², optionally substituted alkoxycarbonyl, optionally substituted aryloxycarbonyl (—COOR²), carboxy (—COOH), optionally substituted acyloxy (—OCOR²), optionally substituted carbamoyl (—CONHR², —CONR²R³), cyano (—CN), dialkyl- or diarylphosphonato [—P(═O)OR²₂], dialkyl- or diarylphosphinato [—P(═O)R²₂], a polymer chain prepared by any polymerization mechanism, —OR² group or —NR²R³ group,
where R² and R³, which are identical or different, are selected from the group consisting of C₁ to C₁₈ alkyl, C₂ to C₁₈ alkenyl, C₆ to C₁₈ aryl, heterocyclyl, aralkyl, and alkaryl, it being possible for each of these groups to be optionally substituted and in which the substituents are chosen from epoxy, hydroxyl, alkoxy, acyl, acyloxy, carboxyl (and its esters and/or salts), sulfonic acid (and its salts and/or sulfonates), alkoxy- or aryloxy-carbonyl, isocyanato, cyano, silyl, halo or dialkylamino.

9. The process as claimed in claim 8, wherein the RAFT agent is chosen from dibenzyl trithiocarbonate (DBTTC) and its derivatives, or 2,2′-[carbonothioylbis(thio)]bis[propionic acid] and its salts.

10. The process as claimed in claim 1, wherein the water being added in step c) is in the form of an aqueous solution having a pH of greater than 7, and wherein said amphiphilic copolymer is obtained and recovered in the form of an aqueous dispersion in step e).

11. The process as claimed in claim 1, wherein the amphiphilic copolymer obtained is subjected, before or after the stage of recovery, to an aftertreatment modifying the trithiocarbonyl groups to obtain a product which is more stable with regard to sources of radicals.

12. The process as claimed in claim 1, further comprising adding one or more odor masking products or odorants during the copolymerization reaction, or else after said reaction, or alternatively during and after said copolymerization reaction.

13. An amphiphilic gradient copolymer obtained, by the process of claim 1 and exhibiting a polydispersity index PI of between 1.2 and 2 and a weight-average molar mass Mw of between 1000 g/mol and 40 000 g/mol, PI and Mw being determined by SEC (steric exclusion chromatography).

14. The amphiphilic gradient copolymer of claim 13 comprising a surfactant for stabilizing emulsions, a dispersant for pigments and/or inorganic fillers, or an agent for helping in the grinding of inorganic fillers which are used in the preparation of formulations for paints, inks or other coating formulations.

15. A block copolymer comprising as one block the copolymer as claimed in claim 13 and the other block(s) resulting from the polymerization of one or more monomers chosen from: alkyl (meth)acrylate, styrene and derivatives, functional (meth)acrylates with acid, anhydride, hydroxyl or amine functionality, poly(ethylene glycol), alone or as a mixture of two or more of them.

16. The process as claimed in claim 4, wherein the amount of hydrophilic monomer(s) is between 25% and 75% by weight, with respect to the total weight of monomer(s).

17. The process as claimed in claim 10, wherein the water being added in step c) in the form of an aqueous solution has a pH of between 8 and 10.

18. The process as claimed in claim 17, wherein the aqueous solution having a pH between 8 and 10, is selected from the group consisting of sodium hydroxide and potassium hydroxide solutions.
